(19) United States
(12) Patent Application Publication
(10) Pub. No.: US 2023/0294555 A1
(43) Pub. Date: Sep. 21, 2023

(54) ELECTRIFIED VEHICLE AND METHOD OF MANAGING POWER SOURCE FOR THE SAME

(71) Applicants: Hyundai Motor Company, Seoul (KR); Kia Corporation, Seoul (KR)

(72) Inventor: Jung Hyun Lee, Yongin (KR)

(21) Appl. No.: 17/944,718

(22) Filed: Sep. 14, 2022

(30) Foreign Application Priority Data
Mar. 17, 2022 (KR) 10-2022-0033529

(51) Int. Cl. B60L 58/20; H02J 7/00; H01M 10/42; H01M 10/48; H01M 50/51; H01M 50/512

(52) U.S. Cl. CPC B60L 58/20; H02J 7/0047; H02J 7/0063; H02J 7/007182; H01M 10/425; H01M 10/482; H01M 50/51; H01M 50/512; H02J 2207/20; H01M 2220/20; H01M 2010/4271; H01M 2010/4278

(57) ABSTRACT

The present disclosure relates to an electrified vehicle and a method of managing a power source for the same, and introduced is an electrified vehicle comprising: a power electric comprising a motor and an inverter; a main battery part electrically connected to the power electric, and comprising a first battery and a first battery control unit configured to control the first battery, but disposed in a fixed type; and a vehicle control unit configured to transmit a required voltage command for a second battery to the first battery control unit by determining a voltage to be supplied to the power electric when a detachable battery part comprising a second battery whose output voltage varies by changing a connection state between a plurality of battery cells and a second battery control unit configured to control the second battery is electrically connected to the main battery part.

### CROSS REFERENCE TO RELATED APPLICATION(S)

The present application claims, under 35 U.S.C. § 119(a), the benefit of Korean Patent Application No. 10-2022-0033529 filed on Mar. 17, 2022, the disclosure of which is incorporated herein by reference in its entirety.

### BACKGROUND

### Technical Field

Embodiments of the present disclosure relate to an electrified vehicle and a method of managing a power source for the same, and more specifically, to an electrified vehicle and a method of managing a power source for the same, which may change a configuration of an internal circuit of a detachable battery to vary the entire voltage of a vehicle in a structure in which the detachable battery directly connected to a main battery is disposed.

### Description of the Related Art

With the recent increase in interest in the environment, the number of electrified vehicles having an electric motor as a power source is increasing.

Although a significant number of users of electrified vehicles have a traveling pattern centered on a short-distance city, the electrified vehicles have a relatively long battery charging time compared to a refueling time of internal combustion engine vehicles, so that the maximum traveling distance of an electric vehicle (EV) at which the vehicle may travel through one-time full charging is important.

However, when a battery capacity is increased to increase the traveling distance of the EV, not only is the weight of the vehicle increased, but also a battery price occupies a big part of electrified vehicles, thereby greatly increasing the price of the vehicle, as well.

In order to solve the problems of the reduced traveling distance and the charging time due to battery deterioration, some manufacturers are also considering replacing the battery by making it detachable. Low-voltage/low-capacity batteries may be applied to small mobilities, such as electric scooters, so that users may directly exchange the battery, but large-capacity batteries for vehicles require a dedicated infrastructure because it is difficult for the user to replace the battery by himself/herself due to weight and safety issues. However, it is necessary to secure a site and replacement equipment at great cost to expand the infrastructure for battery replacement, and there is also a problem in that, even when the infrastructure is equipped, traveling itself becomes difficult when there is physical damage to fastened portions or damage to contact points when the number of replacements is accumulated.

Accordingly, since it is difficult to expand the infrastructure for battery replacement, a method of replacing the battery by detachably attaching a separate battery to a main battery may also be considered. As the method of detachably attaching the separate battery to the main battery to replace the separate battery, there may be a method of connecting the batteries in parallel or in series. Among them, the method of connecting the main battery and the separate detachable battery in series requires a method of varying a voltage of the separate detachable battery according to required voltages of power electric (PE) systems.

The matters explained as the existing technologies are for the purpose of enhancing the understanding of the background of the present disclosure and should not be taken as acknowledging that they correspond to the related art already known to those skilled in the art.

### SUMMARY

An object of the present disclosure is to provide an electrified vehicle and a method of managing a power source for the same, which change a configuration of an internal circuit of a detachable battery to vary the entire voltage of a vehicle in a structure in which the detachable battery directly connected to a main battery is disposed.

As a means of achieving the object, the present disclosure provides an electrified vehicle including: a power electric comprising a motor and an inverter; a main battery part electrically connected to the power electric, and comprising a first battery and a first battery control unit configured to control the first battery, and disposed in a fixed type; and a vehicle control unit configured to transmit a required voltage command for a second battery to the first battery control unit by determining a voltage to be supplied to the power electric when a detachable battery part comprising a second battery whose output voltage varies by changing a connection state between a plurality of battery cells and a second battery control unit configured to control the second battery is electrically connected to the main battery part.

The detachable battery part may be connected to the main battery part in series.

The first battery control unit may be configured to determine an available voltage by changing the connection state between the plurality of battery cells constituting the second battery.

The first battery control unit may be configured to transmit information on the determined available voltage to the vehicle control unit.

The vehicle control unit may be configured to determine a voltage to be supplied to the power electric based on the information on the available voltage transmitted from the first battery control unit.

The vehicle control unit may be configured to control a total available energy of a vehicle to be calculated based on the available voltage transmitted from the first battery control unit.

The first battery control unit may be configured to transmit the required voltage command to a second battery control unit.

The second battery may comprise: a plurality of switching elements configured to change the connection state between the plurality of battery cells, and the second battery control unit may be configured to control operation states of the plurality of switching elements so that the number of battery cells interconnected in series or in parallel between both ends is changed according to the required voltage command.

The second battery control unit may be configured to control a voltage of the second battery to be increased by increasing the number of battery cells connected in series when the required voltage command transmitted from the first battery control unit is increased.

When a sum voltage of the first battery and the second battery is lower than the voltage to be supplied to the power electric, the vehicle control unit may be configured to determine whether an additional voltage boosting of the second battery is possible.

The vehicle control unit may be configured to determine the voltage to be supplied to the power electric again before the second battery reaches a discharge criterion when the additional voltage boosting of the second battery is impossible.

The vehicle control unit may be configured to release the connection with the detachable battery part when the second battery reaches the discharge criterion, and transmit a power of the first battery to the power electric alone.

The vehicle control unit may be configured to determine the voltage to be supplied to the power electric again when the addition voltage boosting of the second battery is possible.

In addition, as a method for achieving the object, the present disclosure provides a method of managing a power source for an electrified vehicle comprising a main battery part electrically connected to a power electric, and comprising a first battery and a first battery control unit configured to control the first battery, and disposed in a fixed type, the method including: an operation of electrically connecting a detachable battery part comprising a second battery whose output voltage varies by changing a connection state between a plurality of battery cells and a second battery control unit configured to control the second battery to the main battery part; an operation of transmitting a required voltage command for the second battery to the first battery control unit by determining a voltage to be supplied to the power electric by a vehicle control unit when the detachable battery part is electrically connected to the main battery part; and an operation of transmitting the required voltage command to the second battery control unit by the first battery control unit, and controlling operation states of a plurality of switching elements so that the number of battery cells interconnected in series or in parallel between both ends is changed according to the required voltage command by the second battery control unit.

According to the electrified vehicle and the method of managing the power source for the same, it is possible to control the energy optimized for the vehicle to be used by changing the configuration of the internal circuit of the detachable battery to vary the entire voltage of the vehicle in the structure in which the detachable battery directly connected to the main battery is disposed.

The effects that can be obtained from the present disclosure are not limited to the above-mentioned effects, and other effects not mentioned will be able to be clearly understood by those skilled in the art to which the present disclosure pertains from the following description.

### BRIEF DESCRIPTION OF THE DRAWINGS

The above and other objects, features and other advantages of the present disclosure will be larger clearly understood from the following detailed description when taken in conjunction with the accompanying drawings, in which:

FIG. 1 is a block diagram showing an electrified vehicle according to an exemplary embodiment of the present disclosure;

FIG. 2 is a diagram showing a location where a detachable battery unit constituting the electrified vehicle of FIG. 1 is disposed;

FIGS. 3 to 5 are diagrams showing an operation state control of a plurality of switching elements of a second battery control unit according to required voltage commands; and

FIG. 6 is a flowchart in which a method of managing a power source of the electrified vehicle of FIG. 1 is operated.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, embodiments disclosed in the present specification will be described in detail with reference to the accompanying drawings, but the same or similar components are denoted by the same reference numerals regardless of reference numerals, and overlapping description thereof will be omitted. The suffixes “module” and “part” for components used in the following description are given or interchangeably used in consideration of only the ease of preparing the specification, and do not have distinct meanings or roles by themselves. In addition, in describing the embodiments disclosed in the present specification, when it is determined that detailed descriptions of related known technologies may obscure the gist of the embodiments disclosed in the present specification, the detailed description thereof will be omitted. In addition, it should be understood that the accompanying drawings are only for easily understanding the embodiments disclosed in the present specification, and the technical spirit disclosed herein is not limited by the accompanying drawings, and the present disclosure includes all changes, equivalents, and substitutes included in the spirit and scope of the present disclosure.

Terms including ordinal numbers such as first and second may be used to describe various components, but the components are not limited by the terms. The terms are used only for the purpose of distinguishing one component from another.

When a certain component is “connected” or “coupled” to another component, it may be directly connected or coupled to another component, but it is understood that other components may also exist therebetween. On the other hand, it should be understood that when it is mentioned that a certain component is “directly connected” or “directly coupled” to another component, other components do not exist therebetween.

The singular expression includes the plural expression unless the context clearly dictates otherwise.

In the present specification, it should be understood that terms such as “comprises” or “has” are intended to specify that the features, numbers, steps, operations, components, parts, or combinations thereof described in the specification exist, but do not preclude the possibility of presence or addition of one or more other features, numbers, steps, operations, components, parts, or combinations thereof.

In addition, a unit or a control unit included in the names of a hybrid control unit (HCU), a vehicle control unit (VCU), etc. is only a term widely used in the naming of a controller configured to control a specific function of a vehicle, and does not mean a generic function unit. For example, each control unit may comprise a communication device configured to communicate with other control units or sensors to control the function in charge, a memory configured to store an operating system or logic commands and input/output information, and one or more processors configured to perform determination, calculation, and decision necessary for controlling the function in charge.

An exemplary embodiment of the present disclosure proposes to integrally manage the power of a main battery and the power of a detachable battery by enabling the detachable (swappable) battery to be additionally connected together with the main battery electrically connected to a driving motor in the electrified vehicle.

In addition, another object of the present disclosure is to apply a variable voltage switching system configured to change a connection state between a plurality of battery cells within a detachable battery in order to vary or stably maintain a voltage transmitted to a driving motor.

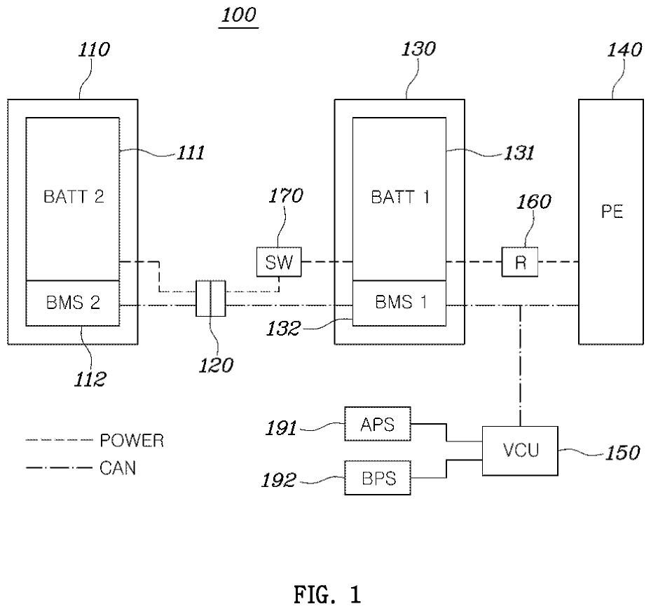

FIG. 1 is a block diagram showing an electrified vehicle according to an exemplary embodiment of the present disclosure. FIG. 1 mainly shows the components related to the present embodiment, and it is natural that a fewer or larger number of components may be included in the implementation of a real vehicle.

Referring to FIG. 1, an electrified vehicle 100 according to an exemplary embodiment may comprise a detachable battery part 110, a connector 120, a main battery part 130, a power electric (PE) 140, a vehicle control unit (VCU) 150, a main relay 160, and a switch 170.

The detachable battery part 110 may comprise a second battery 111 whose output voltage may vary by changing a connection state between a plurality of battery cells and a second battery control unit 112. The second battery control unit 112 may be configured to manage a voltage, current, temperature, and state of charge (SOC), a state of health (SOH), etc. of the second battery 111, and control charging/discharging of the second battery 111. In addition, the second battery control unit 112 may be configured to set and manage upper and lower limits for the SOC of the second battery 111, and store cell type information, rated capacity information, etc. of the second battery 111. In addition, the second battery control unit 112 may be configured to transmit information on the second battery 111 to a first battery control unit 132 through a predetermined vehicle communication protocol (e.g., controller area network (CAN)), and also receive commands for charging/discharging of the second battery 111. For convenience, it is assumed that the vehicle communication protocol is the CAN communication in the following description, but it is apparent to those skilled in the art that other protocols such as flexible data-rate (CAN-FD) and Ethernet may be substituted.

Although not shown in FIG. 1, a cooling device for cooling the second battery 111, for example, an air cooled fan, may also be provided in the detachable battery unit 110, and in this case, the second battery control unit 112 may be configured to control an operation state of a fan depending on the state of the second battery 111, a vehicle speed, etc. Of course, the detachable battery unit 110 may also be cooled in a natural cooling method, or may also be cooled in a water cooled method by disposing a cooling pad through which coolant is circulated in a portion of the vehicle where the detachable battery unit 110 is mounted.

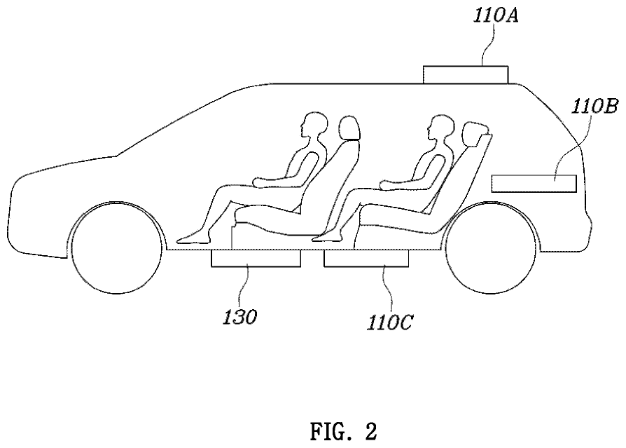

Meanwhile, as shown in FIG. 2, the detachable battery unit 110 may be configured to be mounted on a roof 110 A of the electrified vehicle 100, or may also be accommodated in a space within a trunk 110B or a space under the vehicle 110C, and may also be connected to the vehicle in the form of a trailer by having a separate wheel, but this is illustrative and not necessarily limited thereto.

The detachable battery unit 110 may be configured to be connected in series with the main battery part 130 through the connector 120. Here, “being connected” may mean that a high voltage power cable and a CAN communication line are each connected. Accordingly, a voltage provided to the power electric 140 may be a value obtained by summing voltages of the first battery 131 and the second battery 111, and the first battery control unit 132 and the second battery control unit 112 are in a state of communicating with each other.

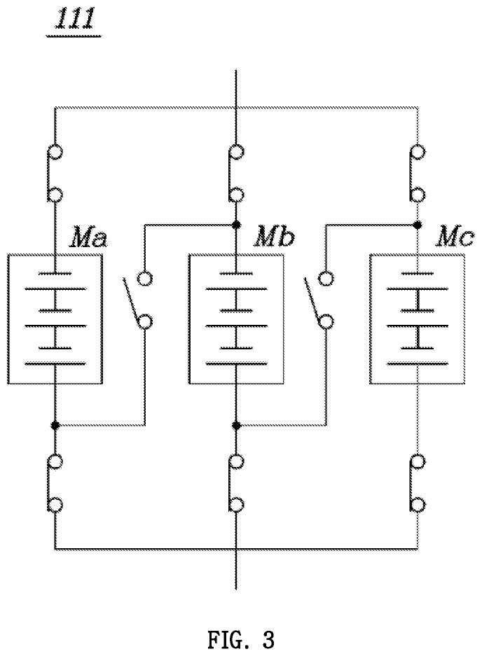

As described above, a variable voltage switching system configured to change a connection state between a plurality of battery cells therein may be applied to the first battery 131. This will be described later with reference to FIGS. 3 to 5.

As shown, the main battery part 130 may comprise the first battery 131 and the first battery control unit 132, and is preferably in a state of being always mounted to the vehicle as a fixed type. When an ignition is on (e.g., IG On or EV Ready), the first battery control unit 132 may be configured to acquire state information of the second battery 111 transmitted by the second battery control unit 112 to the first battery control unit 132 from the first battery control unit 132, and determine a total energy obtained by summing the first battery 131 and the second battery 111 based on the state information. When the second battery control unit 112 does not provide SOC or SOH information but provides only cell type information and rated capacity information, the first battery control unit 132 may be configured to also estimate an SOC and SOH of the second battery 111 based on the provided information. Here, the state information of the second battery 111 may comprise information on a plurality of different voltages that may be provided by changing the connection state between a plurality of cells of the second battery 111, or information for determining the plurality of different voltages (e.g., the number of modules and voltage per unit module).

The main battery part 130 may be configured to be connected to the power electric 140, and the power electric 140 may comprise a motor (not shown) and an inverter (not shown).

The vehicle control unit 150 may be configured to determine a required driving force according to an APS value of an accelerator pedal sensor (APS) 191, determine a driving torque or a regenerative braking torque to be output by the motor of the power electric 140 according to the required driving force or the required regenerative braking force, and transmit torque commands accordingly to a motor control unit (not shown) or an inverter (not shown). Likewise, the vehicle control unit 150 may be configured to determine the required braking force according to a BPS value of a brake pedal sensor (BPS) 192.

In addition, the vehicle control unit 150 may be configured to acquire the state information of each of the first battery 131 and the second battery 111 received from the first battery control unit 132, total available energy information, etc. Here, efficiency information for each output voltage relative to the voltage of the second battery 111 may be provided in the form of a table, and the first battery control unit 132 may also be provided in advance in the vehicle control unit 150 instead of being transmitted to the vehicle control unit 150.

In addition, the vehicle control unit 150 may be configured to determine an optimal efficiency voltage capable of an optimal efficiency operation of the PE system, that is, the power electric 140, and transmit a target voltage command corresponding to the optimal efficiency voltage to the first battery control unit 132. For example, the vehicle control unit 150 may be configured to acquire a target voltage by subtracting the voltage of the first battery 131 from the optimal efficiency voltage, or acquire the target voltage by adding a predetermined margin to the value obtained by subtracting the voltage of the first battery 131 from the optimal efficiency voltage, but this is illustrative and not necessarily limited thereto. At this time, the vehicle control unit 150 may be configured to determine the voltage command for the second battery 111 with a voltage closest to the acquired target voltage among the plurality of voltages that may be provided by the second battery 111 by changing the connection state between internal cells.

The main relay 160 may be disposed between the main battery part 130 and the power electric 140, and the switch 170 may be disposed between the connector 120 and the main battery part 130. For example, when a predetermined information exchange procedure necessary for traveling is completed through communication between the respective control units 112, 132, 150, the relay 160 is short-circuited before the vehicle starts to travel, so that the voltages of the batteries 110, 130 may be transmitted to the power electric 140. In addition, the switch 170 may be configured to cut off the power of the second battery 111, such as exhausting the second battery 111, and may be configured to be controlled as an open state when the first battery 131 alone supplies power to the power electric 140.

Hereinafter, a configuration of the second battery 111 and a method of varying the voltage will be described.

The second battery 111 may comprise a plurality of cells, and the plurality of cells may be grouped into a plurality of modules again. Accordingly, the internal connection state may be changed in a unit of module.

For example, when the second battery 111 includes 60 cells and a single module includes 20 cells, the second battery 111 has three modules. At this time, when the interconnection state is changed in a unit of module, the voltage of the second battery 111 may be determined depending on the number of modules connected in series to each other. The interconnection state between the modules may be changed by controlling a plurality of switching elements. This will be described with reference to FIGS. 3 to 5.

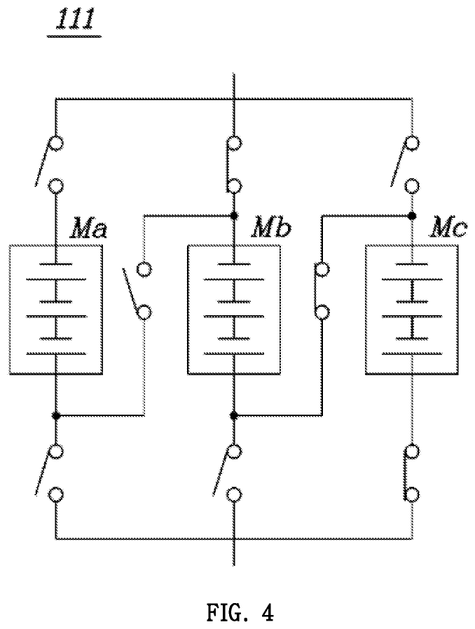

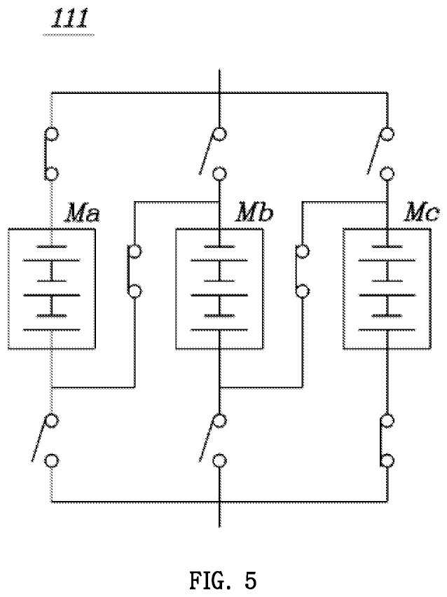

FIGS. 3 to 5 are diagrams showing an operation state control of the plurality of switching elements of the second battery control unit 112 according to the required voltage command. More specifically, FIG. 3 shows a state in which a plurality of modules are interconnected in parallel, FIG. 4 shows a state in which two modules are interconnected in series, and FIG. 5 shows a state in which all of the plurality of modules are interconnected in series.

Referring to FIGS. 3 to 5, the second battery 111 may commonly comprise three different modules Ma, Mb, Mc, and a total of eight switching elements for changing a connection state between each module. Here, on/off states of each of the plurality of switching elements may be controlled by the second battery control unit 112.

FIG. 3 shows a state in which three modules Ma, Mb, Mc are interconnected in parallel. When it is assumed that the voltage of the single module is 73 V, a voltage between both ends of the second battery 111 may be 73 V. The state shown in FIG. 3 is a state in which the second battery 111 has the lowest output available voltage, and may be useful when the required voltage of the second battery 111 is not relatively high because the voltage of the first battery 131 is high.

Next, FIG. 4 shows a state in which two modules Mb, Mc are interconnected in series. Under the same assumption as in FIG. 3, a voltage between both ends of the second battery 111 may be 146 V. However, in the connection state as shown in FIG. 4, since the used modules Mb, Mc and the module not used Ma coexist, the energy of the used modules Mb, Mc is consumed and the energy of the module not used Ma is preserved. Accordingly, since the use of this connection state causes an energy deviation between modules, it is preferable that the use of this connection state is applied through a precise balancing control, such as appropriately changing the used module and the module not used by the second battery control unit 112 through the control of the switching element.

In addition, FIG. 5 shows a state in which three modules Ma, Mb, Mc are interconnected in series. Under the same assumption as in FIG. 3, the voltage between both ends of the second battery 111 may be 219 V. This connection state may be particularly useful when the voltage drop of the first battery 131 is large.

Although it has been assumed that the second battery 111 described so far includes 60 cells but the module is configured in a unit of 20 cells, this is illustrative and is not necessarily limited thereto. For example, it is apparent to those skilled in the art that various modifications may be made, such as using 6 modules in a unit of 10 cells or configuring 4 modules in a unit of 15 cells.

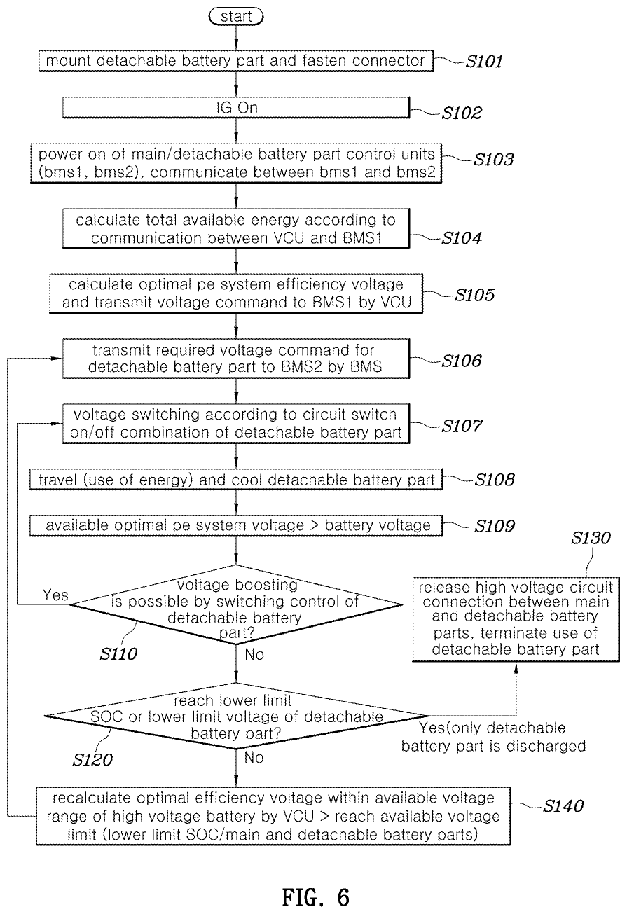

A method of managing a power source for an electrified vehicle according to the embodiment based on the above-described configuration of the vehicle will be described with reference to FIG. 6.

FIG. 6 is a flowchart in which a method of managing a power source of the electrified vehicle of FIG. 1 is operated.

Referring to FIG. 6, the detachable battery part 110 may be mounted on the vehicle, and fastened to the connector 120 connected to the main battery part 130 (i.e., connected to the high voltage power cable and the communication line) (S101).

When the ignition is on after the detachable battery part 110 is connected (S102), as power sources of various electric components such as the second battery control unit 112, the first battery control unit 132, and the vehicle control unit 150 are turned on, communication between the vehicle control unit 150, the first battery control unit 132, and the second battery control unit 112 is started, and information may be exchanged accordingly (S103).

Thereafter, the vehicle control unit 150 calculates the total available energy of the current vehicle based on the information on the first battery 131 and the second battery 111 received from the first battery control unit 132 (S104). The information on the first battery 131 and the second battery 111 received by the vehicle control unit 150 from the first battery control unit 132 includes, for example, the SOC, SOH, temperature information, and voltage information of the first battery 131 and the second battery 111, but is not necessarily limited thereto.

The vehicle control unit 150 may be configured to calculate an optimal efficiency PE system voltage capable of implementing optimal efficiency for driving the power electric 140 based on information obtained through the communication process (S105). The power electric 140 may be configured to implement the most optimal efficiency when the vehicle may implement the optimal travelable distance, and calculate the required voltages of the first battery 131 and the second battery 111 for traveling the optimal travelable distance. At this time, the optimal travelable distance of the vehicle may mean a distance calculated so that the vehicle may travel the longest distance, but is not limited thereto.

In addition, the vehicle control unit 150 may be configured to transmit to the first battery control unit 132 a required voltage command according to the calculated optimal efficiency PE system voltage capable of implementing the optimal efficiency for driving the power electric 140 (S105).

Thereafter, the first battery control unit 132 may be configured to transmit the required voltage command for the second battery 111 to the second battery control unit 112 based on the required voltage command transmitted from the vehicle control unit 150 (S106), and the second battery control unit 112 may be configured to control the second battery 111 to vary the output voltage by changing the connection state between the plurality of battery cells (S107). The change in the interconnection state between the modules may be implemented by controlling a plurality of switching elements, and it has been described above with reference to FIGS. 3 to 5, and thus will be omitted. Here, when the vehicle control unit 150 transmits a voltage command corresponding to the optimal efficiency PE system voltage to the first battery control unit 132, the first battery control unit 132 may be configured to determine the required voltage for the second battery 111 based on a value obtained by subtracting the first battery voltage from the optimal efficiency PE system voltage. On the other hand, when the vehicle control unit 150 directly determines the required voltage for the second battery 111 to transmit the required voltage command for the second battery 111 to the second battery control unit 132, the first battery control unit 132 may be configured to directly transmit the required voltage command to the second battery control unit 112.

Thereafter, since energy is consumed as power supply is started as the vehicle travels, a cooling control for the detachable battery part 110 may be performed (S108). According to an exemplary embodiment, the cooling control may be in the form using a temperature/vehicle speed-based cooling map. For example, when the detachable battery part 110 has a cooling fan as a cooling means, the second battery control unit 112 may be configured to control the cooling fan with reference to a cooling map as shown in Table 1 below.

TABLE 1

| Vehicle speed | A | A + 5 | A + 10 | A + . . . |
|---|---|---|---|---|
| Temperature ° C. | | | | (~maximum |
| | | | | high speed) |
| Cooling start lowest | X | X + y | X + y1 | X + y2 |
| temperature | | | | |
| T + 5 | X1 | X1 + y′ | X1 + y1′ | X1 + y2′ |
| T + 10 | X2 | X2 + y″ | X1 + y1″ | X1 + y2″ |
| T + . . . (~battery | X3 | X2 + z | X1 + z1 | X1 + z2 |
| maximum | | | | |
| temperature) | | | | |

Referring to Table 1, the cooling map may have a form in which the number of operations or duty of the cooling fan is defined according to a plurality of temperature ranges and vehicle speed ranges. However, it is apparent to those skilled in the art that this is illustrative and various modifications may be made. When the first battery 131 and the second battery 111 are discharged according to vehicle operation, a voltage drop may occur.

Accordingly, when the vehicle control unit 150 determines that the sum voltage of the first battery 131 and the second battery 111 is lower than the voltage to be supplied to the power electric 140 (S108), the vehicle control unit 150 may be configured to determine whether the additional voltage boosting of the second battery 111 is possible (S110).

At this time, when the vehicle control unit 150 determines that the additional voltage boosting of the second battery 111 is possible (YES in S110), the second battery control unit 112 may be configured to control the operation states of the plurality of switching elements so that the number of battery cells interconnected in series or in parallel between both ends is changed again according to the required voltage command of the first battery control unit 132. Here, since it is a case in which the voltage boosting is possible, the number of battery cells connected in series is preferably increased compared to the previous state.

Conversely, when the vehicle control unit 150 determines that the additional voltage boosting of the second battery 111 is impossible (NO in S110), the vehicle control unit 150 may be configured to recalculate the voltage to be supplied to the power electric 140 (S140) before the second battery 111 reaches a discharge criterion (NO in S120). Specifically, the vehicle control unit 150 recalculates the optimum efficiency within the voltage range that the first battery 131 may be available to transmit the required voltage command for the second battery 111 to the first battery control unit 132, and the first battery control unit 132 transmits the required voltage command transmitted from the vehicle control unit 150 to the second battery control unit 112.

In addition, when the vehicle control unit 150 determines that additional voltage boosting of the second battery 111 is impossible (NO in S110) and at the same time the second battery 111 reaches the discharge criterion (YES in S120), the vehicle control unit 150 may be configured to release the connection with the detachable battery part 110, and transmit the power of the first battery 131 to the power electric 140 alone (S210). Since only the second battery 111 is discharged, the power of the first battery 131 may be transmitted to the power electric 140 to drive only the first battery 131 alone, and the use of the second battery 111 may be terminated.

As a result, according to the electrified vehicle and the method of managing the power source for the same, it is possible to change the configuration of the internal circuit of the detachable battery to vary the entire voltage of the vehicle in the structure in which the detachable battery directly connected to the main battery is disposed, thereby reducing the capacity of the main battery to save the cost. In addition, the energy optimized for vehicle traveling according to the placement of the detachable battery may be controlled to be used.

Although the specific exemplary embodiments of the present disclosure have been shown and described, it will be apparent to those skilled in the art that the present disclosure may be variously improved and changed without departing from the technical spirit of the present disclosure provided by the appended claims.

What is claimed is:

1. An electrified vehicle, comprising:
a power electric comprising:
a motor; and
an inverter;
a main battery part electrically connected to the power electric, and comprising:
a first battery; and
a first battery control unit, configured to control the first battery, disposed in a fixed type; and
a vehicle control unit configured to transmit a required voltage command for a second battery to the first battery control unit by determining a voltage to be supplied to the power electric when a detachable battery part, comprising:
a second battery whose output voltage varies by changing a connection state between a plurality of battery cells; and
a second battery control unit configured to control the second battery and electrically connected to the main battery part.

2. The electrified vehicle of claim 1, wherein the first battery control unit is further configured to determine an available voltage by changing a connection state between the plurality of battery cells, which constitute the second battery.

3. The electrified vehicle of claim 2, wherein the first battery control unit is further configured to transmit information on the available voltage to the vehicle control unit.

4. The electrified vehicle of claim 3, wherein the vehicle control unit is further configured to determine a voltage to be supplied to the power electric based on the information on the available voltage transmitted from the first battery control unit.

5. The electrified vehicle of claim 3, wherein the vehicle control unit is further configured to control a total available energy of a vehicle to be calculated based on the available voltage transmitted from the first battery control unit.

6. The electrified vehicle of claim 1, wherein the first battery control unit is further configured to transmit the required voltage command to a second battery control unit.

7. The electrified vehicle of claim 6, wherein:
the second battery comprises a plurality of switching elements configured to change the connection state between the plurality of battery cells, and
the second battery control unit is further configured to control operation states of the plurality of switching elements so that a number of battery cells interconnected in series or in parallel between both ends is changed according to the required voltage command.

8. The electrified vehicle of claim 7, wherein the second battery control unit is further configured to control a voltage of the second battery to be increased by increasing the number of battery cells interconnected in series when the required voltage command, transmitted from the first battery control unit, is increased.

9. The electrified vehicle of claim 1, wherein the detachable battery part is connected to the main battery part in series.

10. The electrified vehicle of claim 9, wherein, when a sum voltage of the first battery and the second battery is lower than the voltage to be supplied to the power electric, the vehicle control unit is further configured to determine whether an additional voltage boosting of the second battery is possible.

11. The electrified vehicle of claim 10, wherein the vehicle control unit is further configured to determine the voltage to be supplied to the power electric again before the second battery reaches a discharge criterion when the additional voltage boosting of the second battery is impossible.

12. The electrified vehicle of claim 11, wherein the vehicle control unit is further configured to:
release a connection with the detachable battery part when the second battery reaches the discharge criterion; and
transmit a power of the first battery to the power electric alone.

13. The electrified vehicle of claim 10, wherein the vehicle control unit is further configured to determine the voltage to be supplied to the power electric again when the addition voltage boosting of the second battery is possible.

14. A method of managing a power source for an electrified vehicle comprising: a main battery part electrically connected to a power electric; a first battery; and a first battery control unit configured to control the first battery and disposed in a fixed type, the method comprising:
electrically connecting a detachable battery part, comprising:
a second battery whose output voltage varies by changing a connection state between a plurality of battery cells; and
a second battery control unit configured to control the second battery to the main battery part;
transmitting a required voltage command for the second battery to the first battery control unit by determining a voltage to be supplied to the power electric by a vehicle control unit when the detachable battery part is electrically connected to the main battery part;
transmitting the required voltage command to the second battery control unit, by the first battery control unit; and
controlling operation states of a plurality of switching elements so that a number of battery cells interconnected in series or in parallel between both ends is changed according to the required voltage command, by the second battery control unit.
